(19) United States
(12) Patent Application Publication
(10) Pub. No.: US 2024/0416530 A1
(43) Pub. Date: Dec. 19, 2024

(54) PRECISION HANDLING SYSTEM WITH COMPLIANT GRIPPER

(71) Applicant: FEI Company, Hillsboro, OR (US)

(72) Inventor: Jae Kim, Lake Oswego, OR (US)

(21) Appl. No.: 18/335,759

(22) Filed: Jun. 15, 2023

(51) Int. Cl. B25J 15/00; B25J 9/16

(52) U.S. Cl. CPC B25J 15/0033; B25J 9/1664

(57) ABSTRACT

A precision handling system including a gripper, a flexure, and a ball transfer. The gripper includes a first jaw and a second jaw configured to provide a gripping force therebetween for gripping and moving an object. The flexure is coupled to the gripper and configured to provide compliance in at least one direction. The ball transfer is coupled to the gripper. The ball transfer includes a ball configured to engage the object to transfer the gripping force thereto and configured to spherically rotate to allow the object to move with respect to the first jaw.

### BACKGROUND

The present disclosure relates to a precision handling system. The precision handling system may be for handling a sample holder for transmission electron microscopy (TEM) analysis, and for transferring the sample holder to a sample preparation system. The sample preparation system may include an instrument for milling the sample to a desired thickness, such as a focused ion beam instrument.

### SUMMARY

In one implementation, the disclosure provides a precision handling system including a gripper, a flexure, and a ball transfer. The gripper includes a first jaw and a second jaw configured to provide a gripping force therebetween for gripping and moving an object. The flexure is coupled to the gripper and configured to provide compliance in at least one direction. The ball transfer is coupled to the gripper. The ball transfer includes a ball configured to engage the object to transfer the gripping force thereto and configured to spherically rotate to allow the object to move with respect to the first jaw.

In another implementation, the disclosure provides a sample handling system for use with a charged particle beam system. The sample handling system includes a gripper configured for gripping and moving a lamella carrier holder for supporting a sample. The gripper includes a first jaw and a second jaw configured to provide a gripping force for holding the lamella carrier holder therebetween. The gripper is configured to provide compliance at least in a first direction and in a second direction. The first and second directions are perpendicular to each other.

In another implementation, the disclosure provides a method of using a gripper to handle a sample holder for use with a charged particle beam system. The method includes gripping a lamella carrier holder between first and second jaws of the gripper, mating the lamella carrier holder with a receptacle while gripped between the first and second jaws, and providing gripper compliance in at least in a first direction and in a second direction to facilitate the mating. The first and second directions are perpendicular to each other.

Other aspects of the disclosure will become apparent by consideration of the detailed description and accompanying drawings.

### BRIEF DESCRIPTION OF THE DRAWINGS

FIG. 1 is a schematic diagram of a precision handling system, a sample preparation system, and a robotic cell in accordance with the present disclosure.

FIG. 2 is a perspective view of a holder for use with the precision handling system, the sample preparation system, and the robotic cell of FIG. 1.

FIG. 3 is an exploded perspective view of the holder of FIG. 2 insertable into a receptacle of the sample preparation system shown in FIG. 1.

FIG. 4 is a perspective view of a gripper of the precision handling system shown in FIG. 1 gripping the holder of FIG. 2.

FIG. 5 is a cross-section taken through line 5-5 of FIG. 4.

FIG. 6 is an enlarged perspective view of a second jaw of the gripper of FIG. 4 in a flexed position.

FIG. 7 is a method flow chart in accordance with the present disclosure.

### DETAILED DESCRIPTION

Before any implementations of the disclosure are explained in detail, it is to be understood that the disclosure is not limited in its application to the details of construction and the arrangement of components set forth in the following description or illustrated in the following drawings. The disclosure is capable of other implementations and of being practiced or of being carried out in various ways.

The present disclosure relates to a precision handling system 10 (which may simply be referred to as a handling system 10) for mating a tight tolerance shaft with a tight tolerance aperture. The handling system 10 is configured for gripping and moving an object. The object includes either the shaft or the aperture and is configured to mate with a device having the other of the shaft or the aperture.

Transmission electron microscopes (TEMs) are used for monitoring semiconductor manufacturing processes, analyzing defects, and investigating interface layer morphology. TEMs allow observation of features having sizes on the order of nanometers. The sample must be sufficiently thin to allow many of the electrons in the primary beam to travel though the sample and exit on the opposite side. Because a sample must be very thin for viewing with transmission electron microscopy, preparation of the sample can be delicate and time-consuming.

Some techniques for preparing TEM samples may involve cleaving, chemical polishing, mechanical polishing, or broad beam low energy ion milling. Combinations of these techniques are also possible. These techniques often require that the starting material be sectioned into smaller and smaller pieces, thereby destroying much of the original sample.

Other techniques generally referred to as “lift-out” procedures use a focused ion beam (FIB) to cut the sample from a substrate while greatly limiting or eliminating damage to surrounding areas of the substrate. These techniques are useful for analyzing the results of semiconductor manufacture, for example. A sample is typically prepared from a larger bulk sample by milling away material with an ion beam leaving a thin section referred to as a “lamella.” As the lamella thickness is reduced, it becomes more likely that the region of interest will be excluded from the lamella. Lamellae under 100 nm in thickness, particularly lamellae under 70 nm and even below 30 nm, are difficult to produce either manually or automatically.

Automation of the process of lamella creation to scale up production encounters numerous difficulties. If rotational placement of samples at different angles with respect to the focused ion beam is not done with high precision, significant additional time is required to relocate and re-register the location of the sample with respect to the focused ion beam and/or field of view of imaging detectors. A similar situation arises when removing a sample and replacing the same sample or a different sample into the path of the ion beam. To mitigate these impacts, sample holders can be designed with tight tolerances to promote repeatable positioning. While the movement of sample holders with tight tolerances can be performed manually, this may require breaking and re-establishing vacuum on the system to provide user access at a cost of slowed production and increased contamination risk. Manual placement of sample holders is possible because the human hand has high compliance and can adjust force application and holder positioning during insertion to avoid misalignment. Conversely, automation has conventionally been difficult to achieve as robotic holders are susceptible to jamming or binding the holder during insertion due to the robot's application of force even in the face of misalignment.

Systems and method taught herein provide a precision handling system with high compliance in at least one rotational or translational direction. The provision of compliance in the precision handling system enables repeatable, automated sample placement and movement where tight tolerances are present. In particular, the precision handling system taught herein is suitable for placement of samples into the path of charged particle beams in focused ion beam (FIB) machines, scanning electron microscopes (SEM), transmission electron microscopes (TEM), or systems with a combination of two or more of these.

The illustrated application is only one example, and the handling system 10 may be utilized in any precision handling application, especially when a tight tolerance shaft is inserted into a tight tolerance aperture.

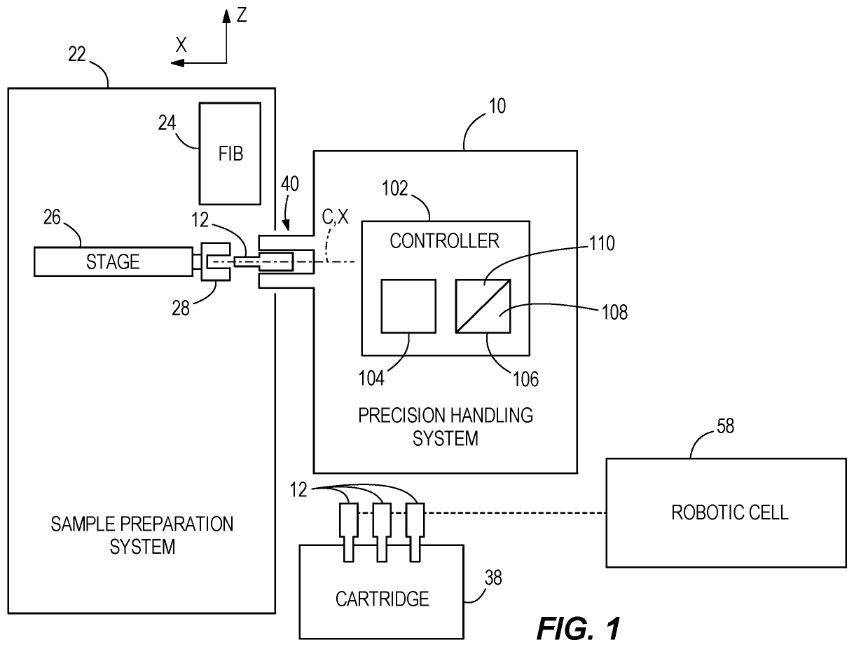

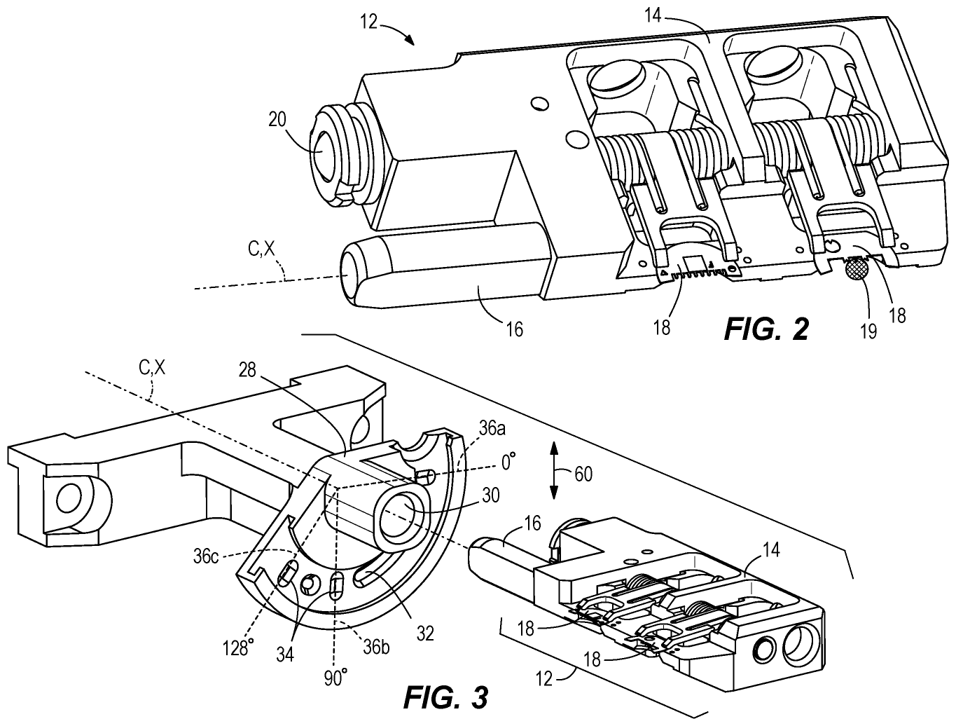

As illustrated in the example of FIGS. 1-7, the handling system 10 may be used to transfer a holder 12, the holder 12 including a holder body 14 and a shaft 16 extending from the holder body 14. Any suitable application for the holder 12 is contemplated. In the illustrated example, with reference to FIG. 2, the holder body 14 holds a lamella carrier 18 configured to support a sample 19 to be analyzed using electron microscopy, e.g., transmission electron microscopy (TEM). The holder 12 may be configured as a dual lamella carrier holder (DLCH), as illustrated, which holds two lamella carriers 18. However, the holder 12 may support any other number of lamella carriers 18, such as one, three, four, or more. The holder 12 includes a sphere 20 extending from the holder body 14 parallel to the shaft 16. In the illustrated implementation, the sphere 20 includes a ball bearing, but any suitable spherical surface, or portion thereof, may be used in other implementations. In other implementations, the sphere 20 need not be spherical and other shapes may be employed, such as partial spheres, other rounded or curved surfaces, etc.

The handling system 10 is configured for gripping the holder 12 and for moving the holder 12 from one location to another. As illustrated in FIG. 1, the handling system 10 is configured to move the holder 12 with respect to a sample preparation system 22. The sample preparation system 22 may move the sample 19 around within the sample preparation system 22 and attach (e.g., weld) the sample 19 to the lamella carrier 18 supported by the holder 12. The sample preparation system 22 includes a sample preparation instrument 24 configured to mill the sample to a desired thickness, e.g., suitable for TEM analysis or for any other purpose. Milling may be performed using one or more high energy beams. For example, the sample preparation instrument 24 may include a focused ion beam (FIB), as illustrated, or may perform laser ablation or any other suitable form of precision milling in other implementations. A robotic cell 58 may be employed to automatically load the lamella carriers 18 onto each holder 12 and, when the milling operation is complete, to unload the lamella carriers 18 from each holder 12 and place fresh lamella carriers 18 in each holder 12.

The sample preparation system 22 includes a stage 26 having one or more receptacles, each receptacle 28 for holding the holder 12 with high positional tolerance for precision milling to be performed on the sample while the holder 12 is held in the receptacle 28. The receptacle 28 includes an aperture 30 configured to receive the shaft 16. In some embodiments, the maximum clearance between the shaft 16 and the receptacle 28 is 30 μm and the minimum clearance is 6 μm. The shaft 16 and the aperture 30 each have a nominal diameter of 2.5 mm in the illustrated implementation but may have other nominal diameters, e.g., in a range from 2.4 mm to 2.6 mm, from 2.0 mm to 3.0 mm, from 1.0 mm to 4.0 mm, or any other nominal diameter in which tight tolerances are required. In other implementations, the holder 12 may include the aperture 30 and the receptacle 28 may include the shaft 16.

The sphere 20 protruding from the holder 12 is configured to be received in an arcuate groove 32 in the receptacle 28 to facilitate rotation of the holder 12 with respect to the receptacle 28, preferably without contacting the receptacle 28 to reduce friction and reduce particle generation. The arcuate groove 32 may include one or more discrete pockets 34 cooperating with the sphere 20 to provide detents. The holder 12 may be inserted at any orientation. For example, the holder 12 may be inserted at an orientation of 0 degrees, e.g., horizontally as illustrated in FIG. 3. As another example, the holder 12 may be inserted at an orientation of −30 degrees (not shown). The holder 12 may be capable of rotation while the shaft 16 is received in the aperture 30. Any orientation, or set of orientations, are contemplated, depending on the application, but in the illustrated implementation it may be desirable to rotate the holder 12 between first, second, and third rotational positions 36a, 36b, 36c. For example, as illustrated in FIG. 3, the first rotational position 36a has the orientation of 0 degrees, which acts as a reference for the other rotational positions 36b, 36c. The second rotational position 36b has an orientation of 90 degrees with respect to the first rotational position 36a, and the third rotational position 36c has an orientation of 128 degrees with respect to the first rotational position 36a, as illustrated in FIG. 3. Any number of positions having any suitable orientation are possible. The rotational positions 36a, 36b, 36c are controlled by the handling system 10.

As illustrated in FIG. 1, a cartridge 38 is configured to support one or more holders 12. In the illustrated implementation, the handling system 10 is configured to transfer the holder 12 from the cartridge 38 to the receptacle 28 on the stage 26. However, the handling system 10 could be used to transfer the holder 12 between any locations. And, the handling system 10 could be used to transfer any object and need not be limited to transferring holders. As such, the holder 12 is only one example and may be referred to more generally as an object 12.

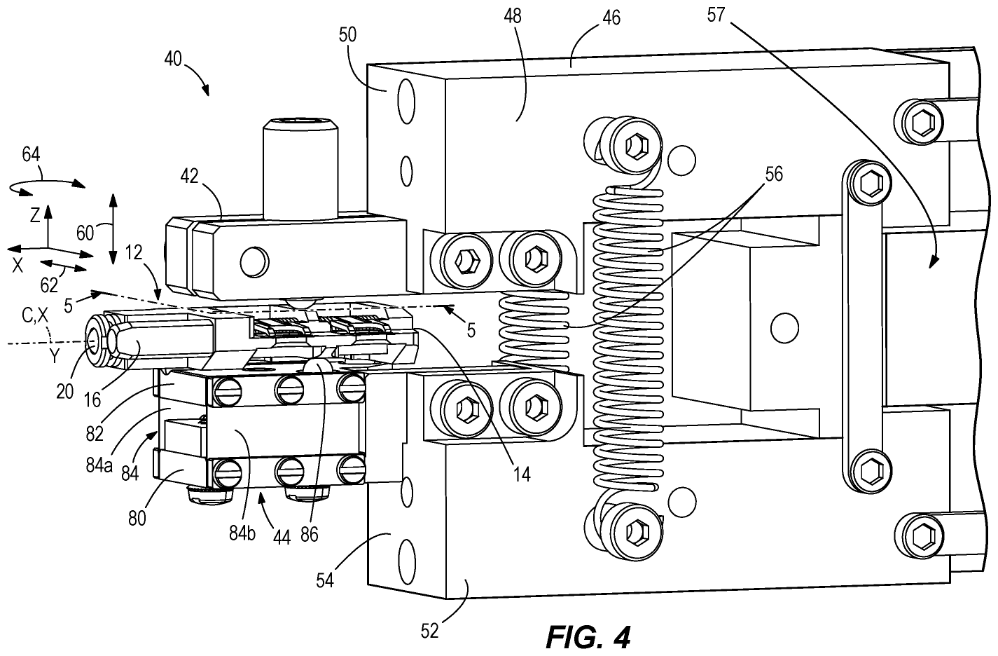

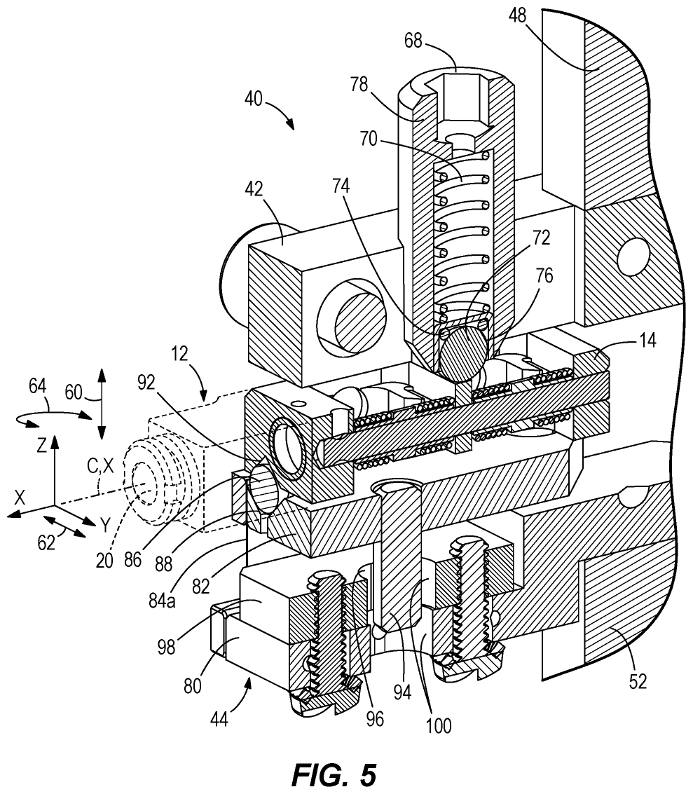

The handling system 10 includes a gripper 40 (best illustrated in FIGS. 4-5) having a first jaw 42 and a second jaw 44 configured to grip the holder 12 therebetween by way of a compressive gripping force. The gripping force may be provided by any suitable means. As best illustrated in FIG. 4, the gripping force may be provided by a generally C-shaped bracket 46 including a first arm 48 having a first free end 50 and a second arm 52 having a second free end 54 and one or more extension springs 56 configured to pull the first arm 48 and the second arm 52 towards each other. The generally C-shaped bracket 46 may also be provided with a piezoelectric actuator 57, the location of which is generally illustrated in FIG. 4. The piezoelectric actuator 57 may be configured to pull the first arm 48 and the second arm 52 towards each other when energized to provide additional gripping force. “Generally C-shaped” should be understood to mean having two arms extending from an intermediate structure, the two arms each having a free end, the two arms being not coaxial with each other. In the illustrated implementation, the first arm 48 may be parallel with the second arm 52, but any suitable orientation in which the first arm 48 is transverse to the second arm 52 is also possible. The generally C-shaped bracket 46 may be configured as a monolithic flexure and may also be referred to herein as a “generally C-shaped flexure.” The generally C-shaped bracket 46 may be made by an electrical discharge machining (EDM) process, or by any other suitable process. The generally C-shaped bracket 46 may provide at least some of the gripping force and/or the one or more extension springs 56 may provide additional gripping force and/or the piezoelectric actuator 57 may provide additional gripping force. Any one of the aforementioned components, or any combination of said components, may provide the gripping force. The one or more extension springs 56 are one example of a biasing member configured to pull the first arm 48 and the second arm 52 towards each other. Other biasing members, such as other types of springs, elastic bands, or other forms of elastomeric materials, are also possible. The first jaw 42 is coupled to the first arm 48, and the second jaw 44 is coupled to the second arm 52. The gripping force may be adjusted by changing the one or more extension springs 56 and/or by energizing and deenergizing the piezoelectric actuator 57.

The gripper 40 is rotatable about a gripper rotation axis X, e.g., the X-axis, between the first, second, and third rotational positions 36a, 36b, 36c while gripping the holder 12. The gripper rotation axis X may correspond to a central axis C of the shaft 16 when the holder 12 and the receptacle 28 are mated. These first, second, and third rotational positions 36a, 36b, 36c may be particularly useful for FIB milling applications, but any rotational position is possible.

The gripper 40 is configured to provide compliance in at least a first direction 60 and a second direction 62 to facilitate mating of the shaft 16 and the receptacle 28. The first direction 60 and the second direction 62 of compliance may be orthogonal to each other. For example, the first direction 60 may be the Z-direction and the second direction 62 may be the Y-direction as illustrated in FIGS. 4-5, but other orthogonal directions are possible. The gripper 40 may provide some compliance about a rotational axis, such as the yaw rotation direction 64 about the Z-axis, in addition to the first direction 60 and the second direction 62.

The first direction 60 of compliance may be provided using any suitable compliance mechanism, which may include any suitable combination of compliance mechanisms. Especially when the gripping force is large (e.g., 4 or more Newtons), it is advantageous to have a compliance mechanism that transfers the gripping force in the Z-direction while complying with movement in the Z-direction. As one example, the generally C-shaped bracket 46 provides compliance in the Z-direction because the first and second arms 48, 52 are spaced from each other in the Z-direction, allowing flexure of the generally C-shaped bracket 46 between the first and second arms 48, 52 in the Z-direction (e.g., flexure of one or both of the first and second arms 48, 52 towards or away from the other thereof). As another example, the one or more extension springs 56 additionally or alternatively provide compliance in the Z-direction because the spring force thereof is oriented at least partially in the Z-direction. Additionally or alternatively, as yet another example, the gripper 40 includes a biased bearing 68 configured to move in the Z-direction, which may be configured as a spring-loaded ball transfer (68). The biased bearing 68 may be supported by the first jaw 42 and configured to transfer the gripping force to the holder 12 while remaining resilient to comply with movement of the holder 12 in the Z-direction. Also, the biased bearing 68 allows the holder 12 to move in an X-Y plane with very low friction while continuously engaging the holder 12 to continuously apply the gripping force to the holder 12.

The biased bearing 68 may have any other suitable configuration in other implementations, e.g., using other types of biasing members and/or other types of bearings. The illustrated biased bearing 68 includes a spring 70, a ball 72, a plurality of sub-balls 74, a carriage 76, and a housing 78. The carriage 76 contains the ball 72 and the plurality of sub-balls 74. The sub-balls 74 provide a bearing for the ball 72 to have spherical rotation with respect to the carriage 76 with very low friction. The carriage 76, the ball 72, and the sub-balls 74 are supported in the housing 78. The spring 70 is configured to bias the carriage 76, the sub-balls 74, and the ball 72 in the direction of the gripping force, i.e., towards the holder 12. The ball 72 is configured to engage the holder 12 and, while engaged with the holder 12, is configured to be spherically rotatable and to simultaneously be movable in the Z-direction as provided for by resilience of the spring 70. In other examples, the first direction 60 of compliance may be provided by a different type of flexure (not shown), such as a blade flexure. If a different type of flexure is used, the flexure needs to be able to move easier than the flexure 84 used for the second direction 62 of compliance, which will be described below.

The second direction 62 of compliance may be provided by using any suitable compliance mechanism. As one example, the gripper 40 includes the second jaw 44, and the second jaw 44 includes a base 80 and a support 82 with a flexure 84 coupled between the base 80 and the support 82. The base 80 and the support 82 are parallel to each other. The base 80 is substantially fixed with respect to the gripper 40, and the support 82 is configured to move with respect to the base 80 by way of the flexure 84. The base 80 and the support 82 may be generally configured as blocks or plates having generally orthogonal outer surfaces but may have any suitable shape.

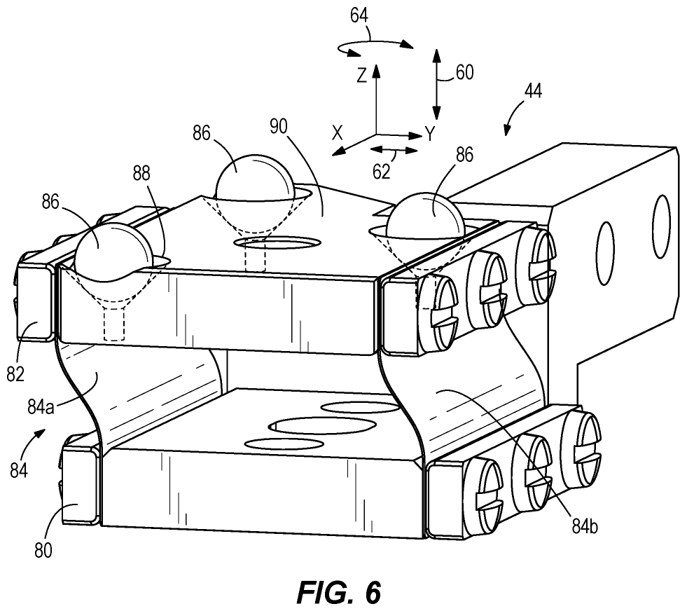

Any suitable type of flexure may be employed. In the illustrated implementation, the flexure 84 is configured as a blade flexure and includes two parallel blades 84a, 84b disposed between the base 80 and the support 82, generally proximate opposite ends thereof in the Y-direction. The thickness of each blade 84a, 84b is 0.002 inches (0.051 mm) but may have other thicknesses in other implementations. For example, the thickness may be from 0.001 inches (0.0254 mm) to 0.009 inches (0.229 mm), from 0.001 inches (0.0254 mm) to 0.005 inches (0.127 mm), from 0.001 inches (0.0254 mm) to 0.003 inches (0.0762 mm), etc. The flexure 84 provides compliance to the support 82 by flexing, primarily in the Y-direction as illustrated in FIG. 6. For example, the flexure 84 may provide at least 96 μm of compliance in the Y-direction per Newton of force. As another example, the flexure 84 may provide 230 μm of compliance in the Y-direction per Newton of force. As another example, the flexure 84 may provide 90-230 μm of compliance in the Y-direction per Newton of force. In other implementations, the second direction 62 of compliance may correspond to 100-150 μm of compliance per Newton of force, or to 10-20 μm of compliance per Newton of force, or 10-230 μm of compliance per Newton of force, etc. The flexure 84 may provide some relatively small parasitic movement in the Z-direction, such as 2.7 μm in the Z-direction per 100 μm of Y-direction movement but is relatively stiff otherwise. The flexure 84 may also provide a small amount of compliance in the yaw rotation direction 64, i.e., rotation about the Z-axis. For example, the compliance in the yaw rotation direction 64 may be about 7.6 arcseconds at 1 Newton (applied to one of the pockets, which will be described in greater detail below). The flexure 84 may be configured as part of the second jaw 44 and provides relative stiffness to the support in the X-direction and the Z-direction. The flexure 84 returns to a neutral home position when forces are removed (as illustrated in FIGS. 4-5). In other implementations, a spring-loaded bearing (not shown) may be employed instead of the flexure. The spring (not shown) of the spring-loaded bearing (not shown) biases the bearing thereof (not shown) to return to the home position when the forces are removed.

With reference to FIGS. 4-6, the support 82 is configured to transfer the gripping force to the holder 12 by way of one or more balls 86 (FIG. 6) configured to engage the holder 12. The support 82 includes pockets 88 formed in a holder-facing surface 90 (FIG. 6) thereof. Each of the pockets 88 is configured as an at least partially conical recess but may have other suitable shapes in other implementations. The holder-facing surface 90 directly faces the holder 12 to be gripped. Each of the one or more balls 86 is at least partially received in one of the pockets 88. The holder body 14 may include corresponding pockets 92 (FIG. 5) for at least partially receiving the one or more balls 86 respectively. Each of the corresponding pockets 92 may also be configured as an at least partially conical recess but may have other suitable shapes in other implementations. The pockets 88, 92 may have a 90-degree vertex in cross-section, as illustrated, but may have other degrees in other implementations. Each of the one or more balls 86 may have a diameter of 2 mm, or any other suitable diameter, e.g., from 1.9 mm to 2.1 mm, from 1.5 mm to 2.5 mm, from 1.0 mm to 3.0 mm, etc. The tolerance of the one or more balls 86 may be at least +/−0.000127 mm, though other tolerances are possible. In some embodiments, the balls 86 can be formed of silicon nitride. Due to the configuration of the pockets 88, 92 and the one or more balls 86, the holder's position with respect to the support 82 is repeatable to a sub-micron level each time the holder 12 is gripped. Thus, the holder 12 is coupled to the support 82 for movement with the support 82, and the support 82 is simultaneously compliant with movement of the holder 12 in the Y-direction and the yaw rotation direction 64 by way of the flexure 84.

As best illustrated in FIG. 5, to inhibit yielding of the flexure 84 material, a pin 94 is fixedly coupled to the support 82 and configured to engage a stop 96 to limit the Y-direction movement of the support 82 and, in turn, the flexure 84. The stop 96 is provided by the base 80 and/or by a block 98 coupled to the base 80. An oversized slot 100 is formed in the base 80 and/or the block 98 for receiving the pin 94 with room for movement. After assembly, a position of the block 98 is adjusted so that the pin 94 is in the middle of the moving range of the flexure 84. For example, the Y-direction movement of the support 82 is limited to +/−200 μm relative to the home position in either direction. The limit may be +300 μm to −300 μm, +200 μm to −200 μm, or +100 μm to −100 μm in some implementations.

The first direction 60 of compliance is oriented orthogonal to the second direction 62 of compliance. Regardless of which rotational position 36a, 36b, 36c (etc.) the gripper 40 is in, the gripper 40 provides consistent compliance in the orthogonal directions. While the gripper 40 is in the first rotational position 36a (e.g., horizontal as illustrated in FIG. 3), the biased bearing 68 provides the first direction 60 of compliance (e.g., the Z-direction, or vertical as illustrated) and the flexure 84 provides the second direction 62 of compliance (e.g., the Y-direction, or horizontal as illustrated). In the second rotational position 36b (e.g., at 90 degrees, or vertical as illustrated), the flexure 84 provides the vertical compliance and the biased bearing 68 provides the horizontal compliance. In between the first and second rotational positions, e.g., if the gripper 40 is rotated a number of degrees (such as 45 degrees in one example) with respect to the first rotational position 36a, the flexure 84 provides compliance at the number of degrees in the Y-Z plane (e.g., at 45 degrees), and the biased bearing 68 still provides compliance orthogonally to the flexure 84, thereby providing a comprehensive compliance solution at any rotational position. By having two orthogonal compliances at the gripper 40, forces on the shaft 16 due to misalignments between the shaft 16 and the aperture 30 are made more consistent, regardless of the rotational position of the gripper 40.

The handling system 10 includes an electronic controller 102 configured to automatically or semi-automatically control the gripper 40. The controller 102 may include a programmable processor 104 (e.g., a microprocessor, a microcontroller, or another suitable programmable device) and a memory 106 such as a non-transitory memory. The memory 106 may include, for example, a program storage area 108 and a data storage area 110. The program storage area 108 and the data storage area 110 can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. Programming may be coded or learned, e.g., by way of a neural network.

As one example, the electronic controller 102 may be configured to control the rotation of the gripper 40 about the gripper rotation axis X to rotate the holder 12 with respect to the receptacle 28 about the central axis C of the shaft 16. The electronic controller 102 may also be configured to control the position of the gripper 40 in 3-dimensional space, e.g., to move the gripper 40 between the cartridge 38 and the receptacle 28, which may include moving in the X-direction, the Y-direction, and/or the Z-direction, in any combination and in any orientation. More specific examples of how the electronic controller 102 is configured are described in the operational description below.

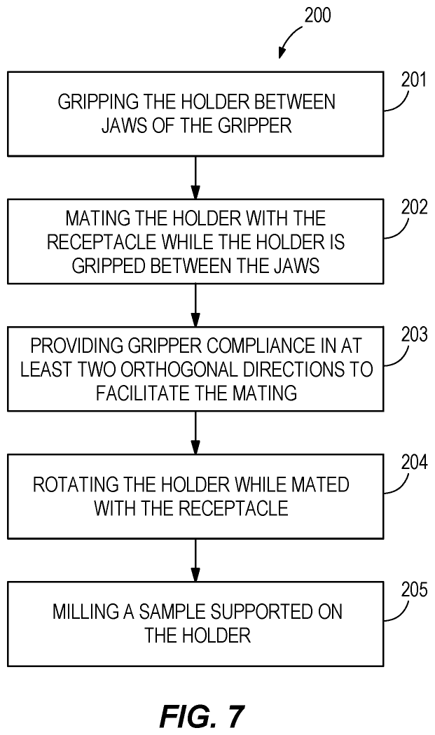

FIG. 7 illustrates a method 200 for using the gripper 40 to handle a transmission electron microscopy (TEM) sample holder 12. At least some of the method 200 may be carried out by the electronic controller 102. At step 201, the gripper 40 grips the holder 12 between the first and second jaws 42, 44. The gripper 40 may remove the holder 12 from the cartridge 38 and move the holder 12 to a desired location, such as to the receptacle 28. At step 202, the gripper 40 mates the holder 12 with the receptacle 28 while the holder 12 is gripped between the jaws 42, 44. Mating may include inserting the shaft 16 into the aperture 30. To facilitate the mating, the gripper 30 provides compliance in at least two orthogonal directions, e.g., the first direction 60 and the second direction 62 as described above (step 203). At step 204, the gripper 40 rotates the holder 12 while mated with the receptacle 28 about the gripper rotation axis X, which corresponds to the central shaft axis C. The gripper 40 may rotate between the first, second, and third rotational positions 36a, 36b, 36c. The second rotational position 36b is 90 degrees from the first rotational position 36a, and the third rotational position 36c is 128 degrees from the first rotational position 36a. At step 205, milling (such as FIB milling) is performed on a sample supported by the holder 12 to reduce the sample to the desired thickness for inspection by transmission electron microscopy. Further method steps and intermediary method steps are apparent from the description above and the operational description below.

In operation, the handling system 10 grips and removes a holder from a first location, such as from the cartridge 38, using the gripper 40. The handling system 10 moves the gripper 40 and the holder 12 gripped therein to a second location, such as the receptacle 28. The handling system 10 inserts the shaft 16 of the holder 12 into the aperture 30 of the receptacle 28. The handling system 10 may rotate the gripper 40 and the holder 12 gripped therein about the gripper rotation axis X, which corresponds to the central axis C of the shaft 16.

The compliant gripper 40 provides advantages. If a shaft (such as the shaft 16) is inserted into a tight hole (such as the aperture 30) with misalignment therebetween, binding may occur. The compliance provided by the gripper 40 reduces misalignment by enabling small translations and rotations to correct misalignments, significantly reducing the likelihood of binding. The gripper 40 creates the compliance needed while maintaining the positional repeatability of the holder 12 in the gripper 40. That is, the kinematic coupling at the second jaw 44, i.e., the one or more balls 86 received in the pockets 88 of the support 82 and in the corresponding pockets 92 of the holder 12, ensures the holder's positional repeatability to a sub-micron level.

The handling system 10 is configured to go to a predetermined location with high positional accuracy and precision. The gripper 40 needs to be able to go to the predetermined position to reduce handling failures. The flexure 84 returns to a consistent home position to make sure the gripper 40 is able to go back to the same predetermined location with high accuracy and precision. The flexure 84 simultaneously provides substantially frictionless compliance. Since the flexure 84 is flexible in a lateral direction, i.e., the Y-direction when the holder is in a horizontal orientation, the flexure 84 allows the holder 12 to move substantially friction-free while the holder 12 is gripped during insertion and extraction. The flexure 84 is stiff in the Z-direction since the flexure 84 is under compression. Thus, the flexure 84 allows the gripper 40 to grip and maintain its grip force. The flexure 84 also allows small compliance in rotation about the Z-axis, i.e., the yaw rotation direction 64. If the holder 12 is not aligned in the yaw rotation direction 64, the flexure 84 can compensate a small amount. The flexure 84 reduces the amount of force and friction between the shaft 16 and the receptacle 28. This lengthens the life of plating on the shaft 16 (e.g., electroless nickel) and generates fewer particles of debris, which may foul the sample preparation system 22 over time.

The gripper 40 rotates about the gripper rotation axis X to position the holder 12 in the first rotational position 36a (e.g., 0 degrees), the second rotational position 36b (e.g., 90 degrees), or the third rotational position 36c (e.g., 128 degrees) for a FIB milling operation. This is called “flip” axis. If the shaft 16 is not perfectly aligned to the gripper rotation axis X (run-out error), the shaft 16 may rub inside the aperture 30 of the receptacle 28 while rotating. The flexure 84 reduces the side load during the rotation step (flip axis of the gripper 40) and during insertion/extraction. Using the biased bearing 68 at the first jaw 42 ensures the friction created by the first jaw 42 allows the flexure 84 to move. Even under high gripping force, the support 82 of the second jaw 44 and the holder 12 can together move freely with respect to the first jaw 42 because the ball 72 rolls. The first and second jaws 42, 44 should have a certain stiffness and mass to keep the natural frequency high enough so that the first and second jaws 42, 44 do not get excited and vibrate. The flexure 84 always returns to the same home position substantially without hysteresis. Thus, the gripper 40 does not deviate from the configured position of the handling system 10.

Thus, the disclosure provides, among other things, a handling system 10 for mating a shaft 16 and a receptacle 28 with high tolerances. The handling system 10 includes a compliant gripper 40 having at least two orthogonal compliance directions. The handling system 10 combines the flexure 84 with the biased bearing 68 to allow the second jaw 44 to move freely with respect to the first jaw 42 even while the first and second jaws 42, 44 exert a gripping force. The disclosure also provides a method of using a gripper to handle a sample holder. Various features and advantages of the disclosure are set forth in the following claims.

What is claimed is:

1. A precision handling system comprising:
a gripper including a first jaw and a second jaw configured to provide a gripping force therebetween for gripping and moving an object;
a flexure coupled to the gripper and configured to provide compliance in at least one direction; and
a ball transfer coupled to the gripper, the ball transfer including a ball configured to engage the object to transfer the gripping force thereto and configured to spherically rotate to allow the object to move with respect to the first jaw.

2. The precision handling system of claim 1, wherein the second jaw includes:
a support for the object, and
a base disposed parallel to the support,
wherein the flexure is disposed between the base and the support, the support being movable in the at least one direction with respect to the base by way of the flexure.

3. The precision handling system of claim 1, wherein the at least one direction is a first direction, wherein the gripper is configured to provide compliance in a second direction different from the first direction, and wherein the first and second directions are perpendicular to each other.

4. The precision handling system of claim 1, wherein the flexure includes at least two parallel blade flexures and/or a generally C-shaped flexure.

5. The precision handling system of claim 1, wherein the gripper is configured to 1) move parallel to an axis for inserting the object into a receptacle and 2) to rotate about the axis for rotating the object within the receptacle.

6. The precision handling system of claim 5, wherein the gripper is configured to automatically mate the object with the receptacle by inserting a shaft into an aperture aligned with the axis, and configured to automatically rotate the object about the axis, wherein a clearance between the object and the receptacle is 30 micrometers or less.

7. The precision handling system of claim 1, wherein the gripper is configured to mate the object with a receptacle, wherein a clearance between the object and the receptacle is 30 micrometers or less.

8. The precision handling system of claim 1, wherein the flexure is configured to provide rotational compliance about a rotational compliance axis that is perpendicular to the at least one direction.

9. The precision handling system of claim 1, further comprising an electronic controller configured to control the gripper.

10. A sample handling system for use with a charged particle beam system, the sample handling system comprising:
a gripper configured for gripping and moving a lamella carrier holder for supporting a sample, the gripper comprising
a first jaw and a second jaw configured to provide a gripping force for holding the lamella carrier holder therebetween,
wherein the gripper is configured to provide compliance at least in a first direction and in a second direction, wherein the first and second directions are perpendicular to each other.

11. The sample handling system of claim 10, wherein the gripper includes:
one or both of a generally C-shaped flexure or a biasing member configured to provide the first direction of compliance, and
a flexure configured to provide the second direction of compliance.

12. The sample handling system of claim 11, wherein the flexure includes at least two parallel blade flexures.

13. The sample handling system of claim 10, wherein the gripper is configured to 1) move parallel to an axis and 2) rotate about the axis, and wherein the first direction of compliance, the second direction of compliance, and the axis are orthogonal to each other.

14. The sample handling system of claim 13, wherein the gripper is configured to mate the lamella carrier holder with a receptacle by inserting a shaft into an aperture aligned with the axis, and configured to rotate the lamella carrier holder about the axis, wherein a clearance between the lamella carrier holder and the receptacle is 30 micrometers or less.

15. The sample handling system of claim 10, wherein the gripper is configured to mate the lamella carrier holder with a receptacle.

16. The sample handling system of claim 10, further comprising an electronic controller configured to control the gripper.

17. A method of using a gripper to handle a sample holder for use with a charged particle beam system, the method comprising:
gripping a lamella carrier holder between first and second jaws of the gripper;
mating the lamella carrier holder with a receptacle while gripped between the first and second jaws; and
providing gripper compliance in at least in a first direction and in a second direction to facilitate the mating, wherein the first and second directions are perpendicular to each other.

18. The method of claim 17, further comprising:
rotating the lamella carrier holder while mated with the receptacle between a first rotational position, a second rotational position, and a third rotational position;
wherein the second rotational position is 90 degrees from the first rotational position, and the third rotational position is 128 degrees from the first rotational position.

19. The method of claim 17, further comprising using an electronic controller to control the gripping and the mating.

20. The method of claim 17, further comprising:
providing the first direction of gripper compliance with one or both of a generally C-shaped flexure or a biasing member;
providing the second direction of gripper compliance with a blade flexure; and
providing a ball transfer to engage the lamella carrier holder.
